(19) United States
(12) Patent Application Publication
(10) Pub. No.: US 2013/0186252 A1
(43) Pub. Date: Jul. 25, 2013

(54) HAMMER BUTT FOR UPRIGHT PIANO ACTION WITH HALF-CONICAL HAMMER SHANK HOLE

(71) Applicants: Kirk Burgett, Sacramento, CA (US); Jamie Marks, Haverhill, MA (US); Dana Mazzaglia, Haverhill, MA (US)

(72) Inventors: Kirk Burgett, Sacramento, CA (US); Jamie Marks, Haverhill, MA (US); Dana Mazzaglia, Haverhill, MA (US)

(21) Appl. No.: 13/354,240

(22) Filed: Jan. 19, 2012

(51) Int. Cl. G10C 3/18

(52) U.S. Cl. 84/254

(57) ABSTRACT

A hammer butt for an upright piano with a half-conical hammer shank hole located on the top of said hammer butt which has a cylindrical-shaped cross section as viewed from the side of said hammer butt flange and a trapezoidal-shaped cross section as viewed from the front of said hammer butt, with the bottom of said half-conical hammer shank hole representing the short side of said trapezoidal-shaped front cross section.

### BACKGROUND OF THE INVENTION

1. Field of the Invention

This invention relates to upright piano actions, or more specifically the mechanisms in upright pianos that transmit motion from a piano player's fingers into motion of a hammer, located inside the piano, causing the hammer to strike a piano string, thereby producing sound or music from the piano. A piano action is a complicated assembly of smaller mechanical components. In every piano, there is a separate piano action and hammer corresponding to each piano key, where there are typically 88 keys in a piano. This invention relates to one subcomponent of an upright piano action, namely the hammer butt as detailed below.

2. Description of Related Art

An upright piano action comprises the following interconnected subcomponents: a dowel capstan, a whippen, a jack, a hammer butt, a damper lever, a hammer shank, and a hammer. Basically, when a piano player presses down on a piano key, this causes the back side of the key, located inside the piano, to rise upwards in response. The back side of the piano key then pushes upwards on the dowel capstan, which in turn pushes upwards on the whippen, causing the whippen to rotate. As the whippen rotates, it pushes on the damper lever, rotating the damper lever in the opposite direction, to lift damper off the piano strings. The rotating whippen also pushes on the jack, lifting the jack upwards. The jack in turn pushes upwards on the hammer butt, causing the hammer butt to rotate, which causes the hammer shank and hammer to rotate because the hammer butt is rigidly connected to the hammer shank, which is rigidly connected to the hammer. Rotation of the hammer causes the hammer to strike one or more piano strings, thereby creating music or sound in the piano.

As discussed below, with an upright piano action, the hammer is attached or mounted to the hammer shank at an angle, so to speak, where the hammer is leaned or tilted to one side or the other as mounted on the hammer shank. Also, at the other end of the hammer shank, the hammer shank is attached or mounted to the hammer butt also at an angle, so the hammer shank is leaned or tilted to one side or the other as mounted on the hammer butt.

In order to manufacture upright piano actions with the above referenced tilt designs in the hammer assemblies, piano manufacturers have “tapered” or “shaved” cylindrical hammer shanks in various ways in order to effect this tilt design. As discussed below, a tapered hammer shank allows angled or tilted assembly of a hammer shank to a hammer butt.

This invention does not teach the tapering or shaving of the hammer shank in order to effect the angled or tilted assembly of a hammer shank to a hammer butt. This invention teaches the use of a precisely shaped half-conical hole in the hammer butt, into which the hammer shank is mounted, to yield the required angled or tilted assembly of a hammer shank to a hammer butt.

### BRIEF SUMMARY OF THE INVENTION

It is an aspect of this invention to provide a hammer butt for an upright piano action that is a precisely shaped molded article, wherein this precisely shaped molded article includes a precisely shaped and located “half-conical shaped” hammer shank hole on its upper surface, in which the hammer shank is mounted at a precise tilt angle in relation to the hammer butt.

It is an aspect of this invention to provide a hammer butt for an upright piano action that is a precisely shaped molded article, wherein this precisely shaped molded article includes a precisely shaped and located “half-conical shaped” hammer shank hole on its upper surface, wherein the half-conical hammer shank hole has a cylindrical cross section as viewed from the side and a trapezoidal cross section as viewed from the front.

It is an aspect of this invention to provide a hammer butt for an upright piano action with a “half-conical shaped” hammer shank hole on its upper surface, wherein the half-conical hammer shank hole has a cylindrical cross section as viewed from the side and a trapezoidal cross section as viewed from the front, where the trapezoidal sides of the hammer shank hole are at an angle from vertical plumb ranging from plus or minus 0.1-10 degrees.

It is an aspect of this invention to provide a hammer butt for an upright piano action that is easily affixable to a hammer shank to yield a hammer shank mounting angle that is plus or minus 10 degrees from vertical plumb, where the hammer shank does not include any tapering or shaving on an end.

It is an aspect of this invention to provide a hammer butt for an upright piano action, capable proper assembly at a precise left or right tilt angle, that ranges from plus or minus 10 degrees from vertical plumb, where the hammer shank is a rigid hollow thin-walled tubular-shaped member without tapering or shaving on an end.

It is an aspect of this invention to provide a hammer butt for an upright piano action that does not require the second operation of tapering or shaving of the shank at one end in order to precisely mount the hammer shank at the exact specific left or right angle that is required for the proper installation and clearance of all 88 hammers of a piano action.

### BRIEF DESCRIPTION OF THE DRAWINGS

FIG. 1 is a left perspective view of a prior art upright piano action.

FIG. 2 is a right perspective view of a prior art upright piano action.

FIG. 3 is, going from left to right, a front elevation view a prior art bass hammer shank and hammer assembly before tapering, a front elevation view of a prior art treble hammer shank and hammer assembly before tapering, a side elevation view of a prior art bass or treble hammer shank and hammer assembly after tapering, and a front elevation view of a prior art treble hammer shank and hammer assembly after tapering.

FIG. 4 is a side elevation view of a prior art hammer butt.

FIG. 5 is a top plan view of a prior art hammer butt defining a cross-sectional view thereof, along with the defined cross-sectional view of prior art hammer butt.

FIG. 6 is a left perspective view a prior art hammer shank and hammer butt, just prior to assembly.

FIG. 7 is a left perspective view a prior art hammer shank and hammer butt, after assembly.

FIG. 8 is a perspective view of hollow hammer shank defining a blow-up view of one end, along with the defined blow-up view of the end of hollow hammer shank.

FIG. 9 is a left perspective view of an assembled upright piano action with hammer butt with half-conical hammer shank hole.

FIG. 10 is a side elevation view of hammer butt with half-conical hammer shank hole.

FIG. 11 is a top plan view of hammer butt with half-conical hammer shank hole defining a cross-sectional view thereof, along with defined the cross-sectional view of hammer butt with half-conical hammer shank hole.

FIG. 12 is a side elevation view of hammer butt with half-conical hammer shank hole defining a cross-sectional view thereof, along with the defined cross-sectional view of hammer butt with half-conical hammer shank hole.

FIG. 13 is a is a side elevation view of hammer butt with half-conical hammer shank hole defining two additional cross-sectional views thereof, along with the two additional defined cross-sectional views of hammer butt with half-conical hammer shank hole.

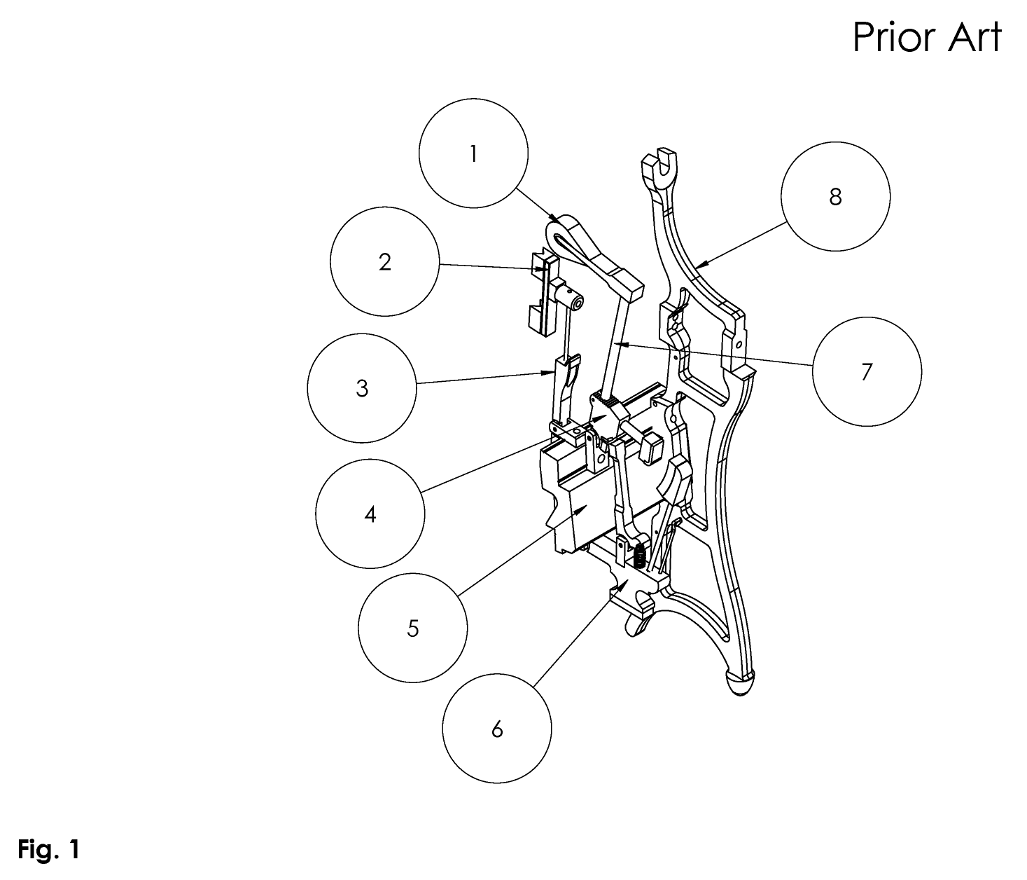

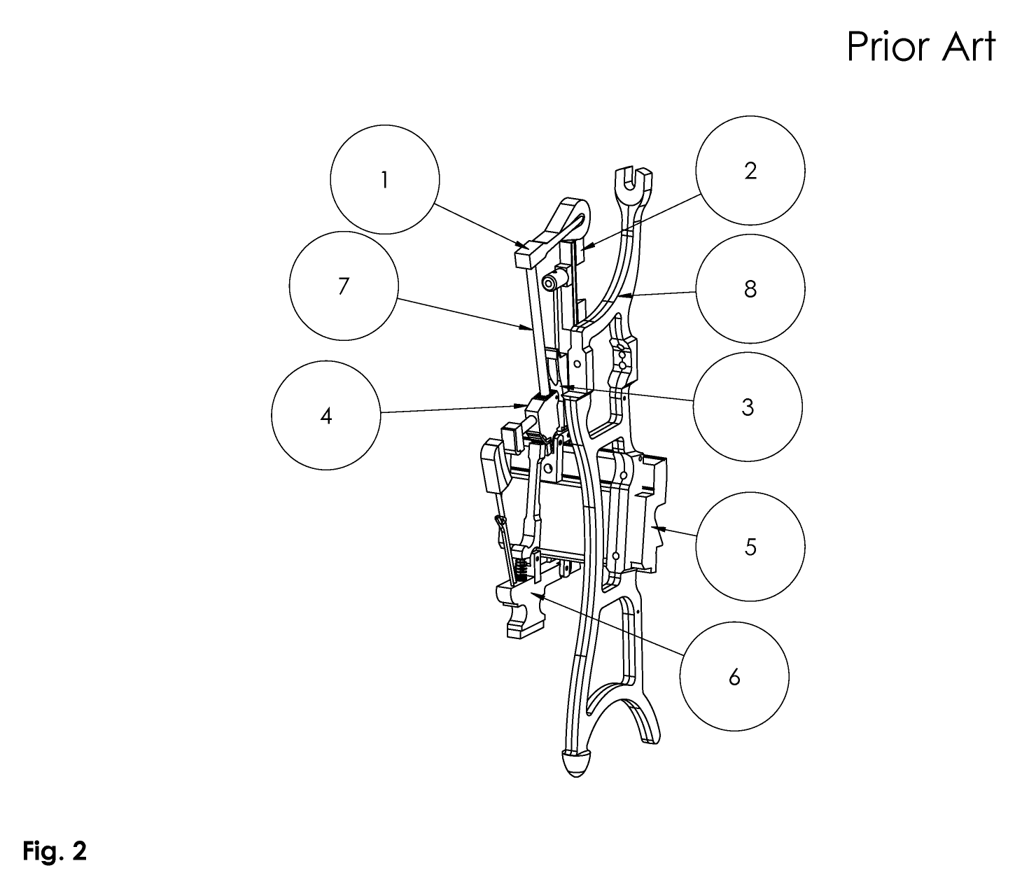

DEFINITION LIST

| Term | Definition |
|---|---|
| 1 | Hammer |
| 2 | Damper |
| 3 | Damper Lever |
| 4 | Prior Art Hammer Butt |
| 5 | Action Rail |
| 6 | Whippen |
| 7 | Prior Art Hammer Shank |
| 8 | Action Bracket |
| 9 | Hammer with mounting hole drilled at bass string angle |
| 10 | Hammer with mounting hole drilled at treble string angle |
| 11 | Prior Art Hammer Shank cut to length |
| 12 | Prior Art Hammer Shank - no taper front-to-back |
| 13 | Prior Art Hammer Shank - tapered side-to-side |
| 14 | Prior Art Hammer Butt (Blow-up view) |
| 15 | Center Pin Clamping Plate |
| 16 | Hammer Butt Flange |
| 17 | Hammer Butt Felt |
| 18 | Hammer Butt Buckskin |
| 19 | Catcher Dowel |
| 20 | Catcher Buckskin |
| 21 | Catcher |
| 22 | Cylindrical Hammer Shank Hole in Prior Art Hammer Butt |
| 23 | Side Tapering in Prior Art Hammer Shank |
| 24 | No Tapering on front and back of Prior Art Hammer Shank |
| 25 | Cylindrical Hammer Shank Hole filled with gap filling glue |
| 26 | Hammer Shank with hollow thin-walled tubular-shape |
| 27 | Thin wall of Hammer Shank |
| 28 | Hollow Area of Hammer Shank |
| 29 | Hammer Shank with hollow thin-walled tubular-shape |
| 30 | Hammer Butt with Half-Conical Hammer Shank Hole |
| 31 | Hammer Butt Flange |
| 32 | Half-Conical Hammer Shank Hole Housing |
| 33 | Spring Mounting Hole |
| 34 | Center-of-Rotation of Hammer Butt |
| 35 | Hammer Butt Flange |
| 36 | Hammer Butt Felt |
| 37 | Hammer Butt Buckskin |
| 38 | Catcher Buckskin |
| 39 | Catcher |
| 40 | Fandrich Holes |
| 41 | Half-Conical Hammer Shank Hole with parallel surfaces |
| | front-to-back |
| 42 | Half-Conical Hammer Shank Hole with concave upwards |
| | surfaces side-to-side |
| 43 | Top Area of Half-Conical Hammer Shank Hole |
| 44 | Interior Surfaces of Half-Conical Hammer Shank Hole |
| | parallel here |
| 45 | Interior Surfaces of Half-Conical Hammer Shank Hole |
| | conical here |
| 46 | Bottom Area of Half-Conical Hammer Shank Hole |
| 47 | Circular Bottom of Half-Conical Hammer Shank Hole |
| 48 | Strike Line |
| 49 | “Note 1” on the Piano |
| 50 | “Note 88” on the Piano |
| 51 | Cut-away of Exterior of Upright Piano |
| 52 | Treble Piano Strings |
| 53 | Bass Piano Strings |
| 54 | Front Cut-away view depicting the Piano Strings in an |
| | Upright Piano |

### DETAILED DESCRIPTION OF THE INVENTION

An upright piano action comprises the following interconnected subcomponents: a dowel capstan (not depicted), a whippen 6, a jack (depicted, not labelled), a hammer butt 4, 14, 30, a damper lever 3, a damper 2, a hammer shank 7, 11, 12, 13, 26, 29 and a hammer 1, 9, 10. Basically, when a piano player presses down on a piano key (not depicted), this causes the back side of the key, located inside the piano, to rise upwards in response. A piano key is a pivoting member teetering upon a center balance point. The back side of the piano key then pushes upwards on the dowel capstan (not depicted), which in turn pushes upwards on the whippen 6, causing the whippen 6 to rotate. As the whippen 6 rotates, it pushes on the damper lever 3, rotating the damper lever 3 in the opposite direction, to lift damper 2 off the piano strings (not depicted). The rotating whippen 6 also pushes on the jack, lifting the jack upwards. The jack in turn pushes upwards on the hammer butt 4, causing the hammer butt 4 to rotate, which causes the hammer shank 7 and hammer 1 to rotate, as the hammer butt 4 is rigidly connected to hammer shank 7 which is rigidly connected to hammer 1. Rotation of hammer shank 7 causes hammer 1 to strike one or more piano strings, thereby creating music or sound in the piano.

Upright pianos are typically of a “over-strung” design, meaning that the piano strings are positioned at a diagonal inside the rectangular box frame of the upright piano. The diagonal fit of the strings provides the ability to string and fit longer piano strings inside a smaller box, as opposed to just stringing parallel to the sides of the rectangular box frame of the upright piano.

In FIG. 14, we depict the basic design of an over-strung upright piano. The rectangular box 51 represents a cut-away view of the rectangular box frame of the upright piano as seen from the front of the upright piano positioned on a horizontal surface. Typically, the bass strings 53 are strung downward from left to right fashion as seen from the front of the piano, and the treble strings 52 are strung upward from left to right as seen from the front of the piano, according to FIG. 14.

The individual points where hammers 1 strike the piano strings 52, 53, for each of the 88 keys in the piano, form a line, called the “strike line” 48. Note that the strike line 48 is a horizontal line that runs parallel to the horizontal row of pianos keys (not depicted), which is positioned slightly below and forward to the strike line 48. The keys are positioned in a horizontal row for ease of piano playing for the pianist. Strike line 48 is a parallel to the horizontal row of the piano keys because each the piano actions is of an overall similar size, which leads to hammers 1 striking points on the strings 52, 53 along a line parallel to the horizontal row of keys. Traditionally and typically, upright pianos are designed, built, and tuned with a designated specific strike line 48 set at a specific location on the strings 52, 53, so the piano should maintain this strike line 48 very accurately and precisely in order to maintain the piano in peak form.

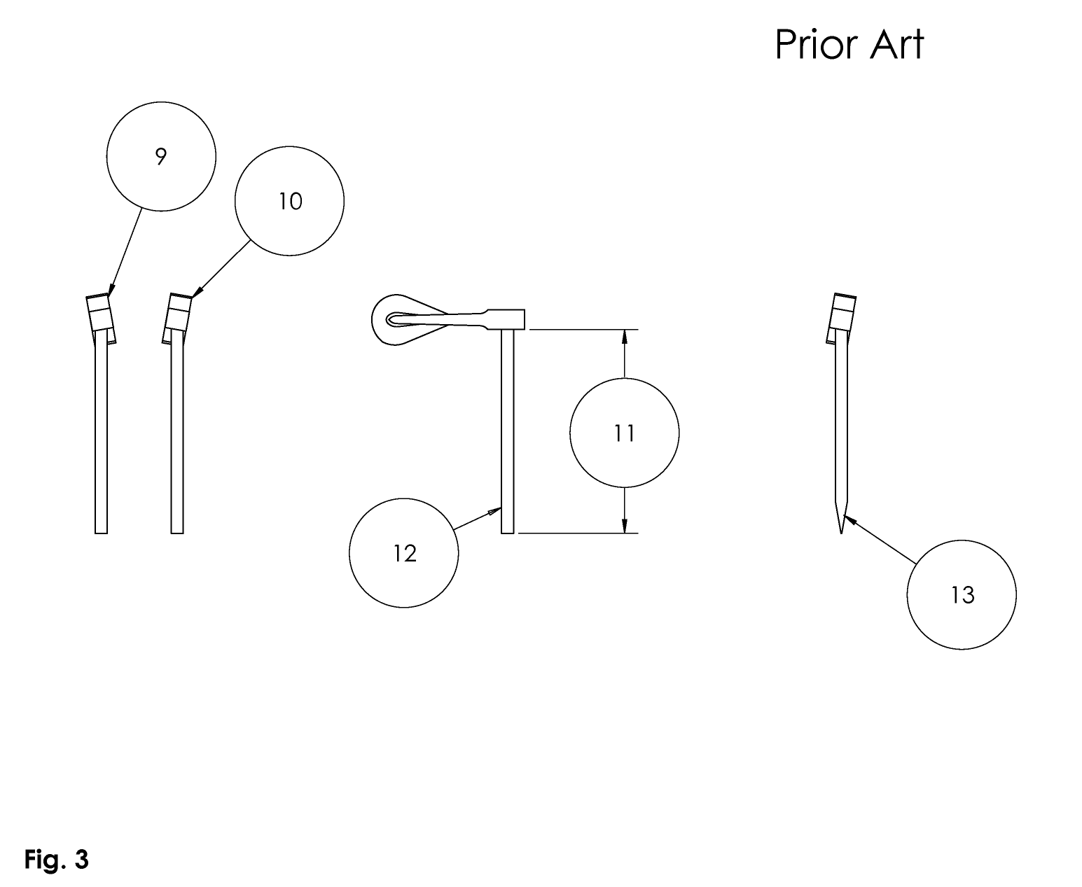

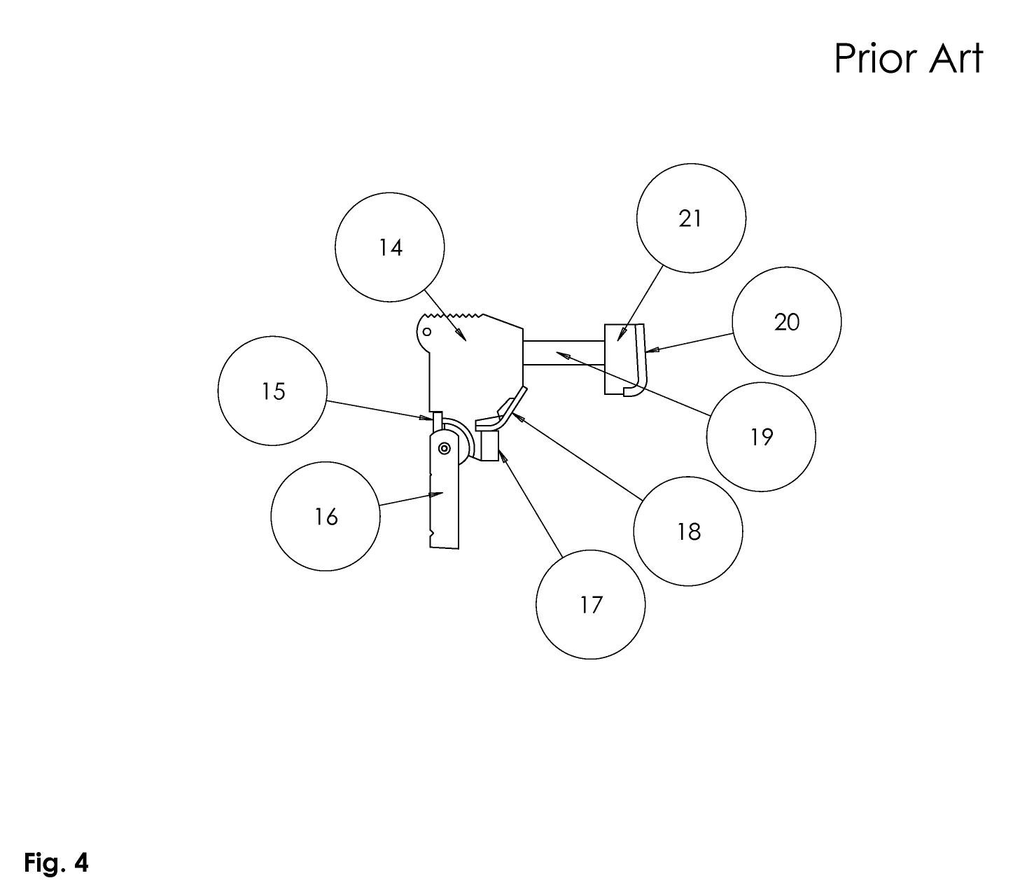

Further, traditionally and typically, upright pianos are designed, built, and tuned so that hammers 1 strike the piano strings 52, 53 in parallel, so that the top-to-bottom axis of hammer 1 is in alignment with the running axis of its corresponding target string, one of 52 or 53. That is to say that hammers must strike strings this way in order to yield optimal sound of the piano. FIG. 3 describes this alignment further. In FIG. 3, hammer 9 is rigidly connected to the hammer shank at a titled angle, leaning towards the left. This tilt is to insure that hammer 9 is parallel to bass string 53, as hammer 9 strikes bass string 53, in response to a depression on the corresponding piano key by the pianist. Similarly, hammer 10 is rigidly connected to the hammer shank at a titled angle, leaning towards the right. This tilt is to insure that hammer 10 is parallel to treble string 52, as hammer 10 strikes treble string 53, in response to a depression on the corresponding piano key by the pianist. Thus, the tilt of the mount here must match the degree of tilt from vertical plumb of the target piano strings 52 or 53.

Typically, the tilted mounts of hammers 9, 10 on hammer shanks is achieved by drilling or boring a mounting hole in the bottom of a hammer 9, 10 at the appropriate angle, so that the cylindrically shaped hammer shank may slide into the mounting hole and mount hammer 9, 10 at the appropriate angle to allow the hammer 9, 10 to strike in parallel with its target piano string or strings 52, 53.

Traditionally and typically, each hammer shank 11 of an upright piano is hand-cut to its proper length to insure the proper striking point of hammer 11 on striking line 48.

Traditionally and typically, during the final production stage of an upright piano action, where the 88 actions are mounted to the action rail 5, the piano assembly technician requires the ability to make fine adjustments in the side-to-side mounting angle between hammer shank 7, 26 and hammer butt 4, 14, 30. Upright piano actions have a target design angle of 90 degrees here so that hammer shank 7, 26 is held exactly vertically plumb as seen from the front of the piano. However, invariably, the piano assembly technician requires the ability to make fine adjustments in this angle, about 0-10 degrees, in order to effect the proper clearances between the 88 hammers of the piano action as required for proper actuation of the piano action. Thus, the piano assembly technical requires the ability to adjust the side-to-side angle of the mount between the hammer shank and the hammer butt.

In the prior art, this adjustment is achieved by shaving or tapering one or both sides of the hammer shank 7, 11, 12, 13 in order to fit the hammer shank 7, 11, 12, 13 into the cylindrical hammer shank hole 22 of hammer butt 4, 14 at the proper clearance angle. Note that no shaving or tapering is done on the front or back of the hammer shank because, traditionally and typically, no adjustment in this axis is necessary to achieve the proper installation of piano actions. The side-to-side adjustment of the hammer shanks is also traditionally and typically done by hand for each of the 88 hammer shanks in the piano action.

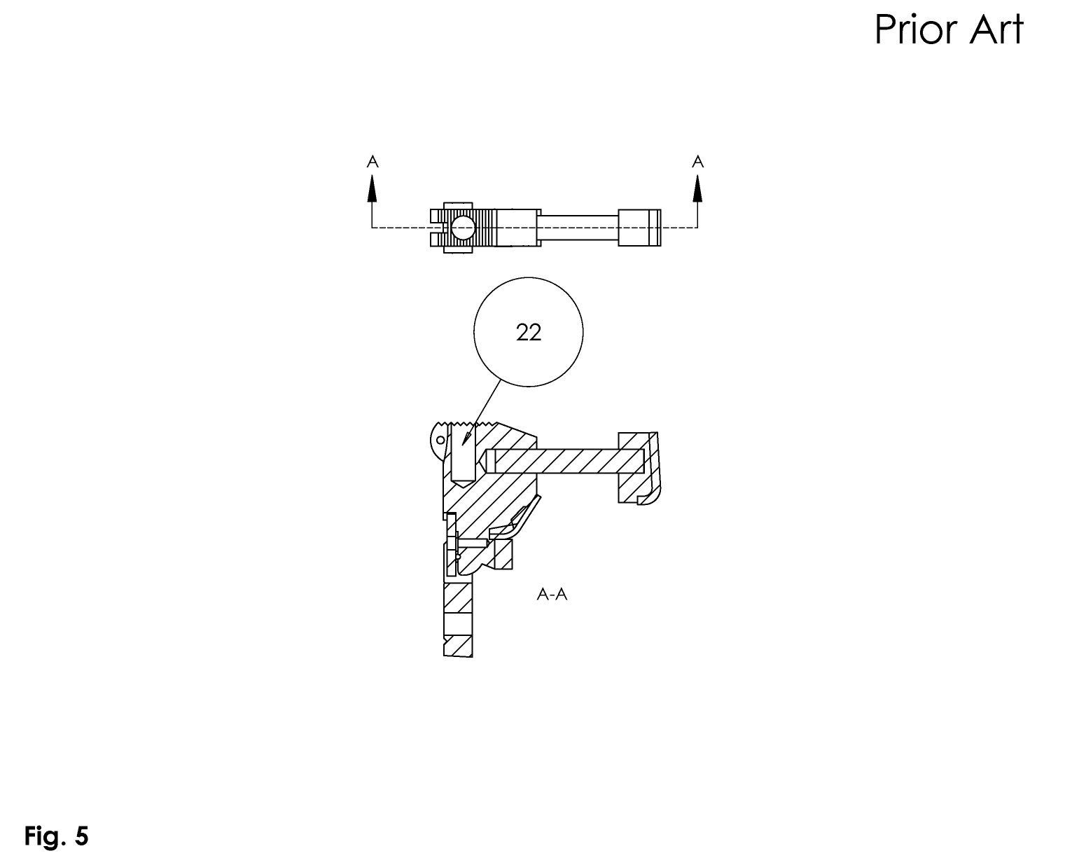

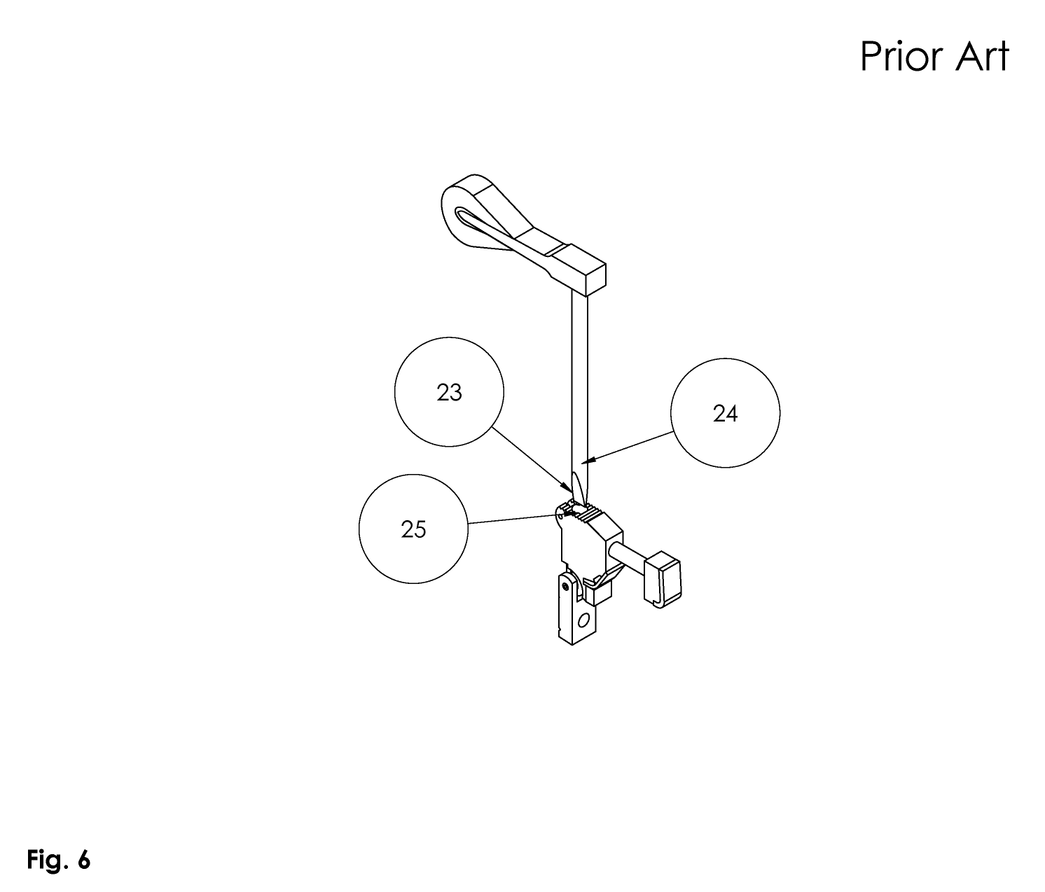

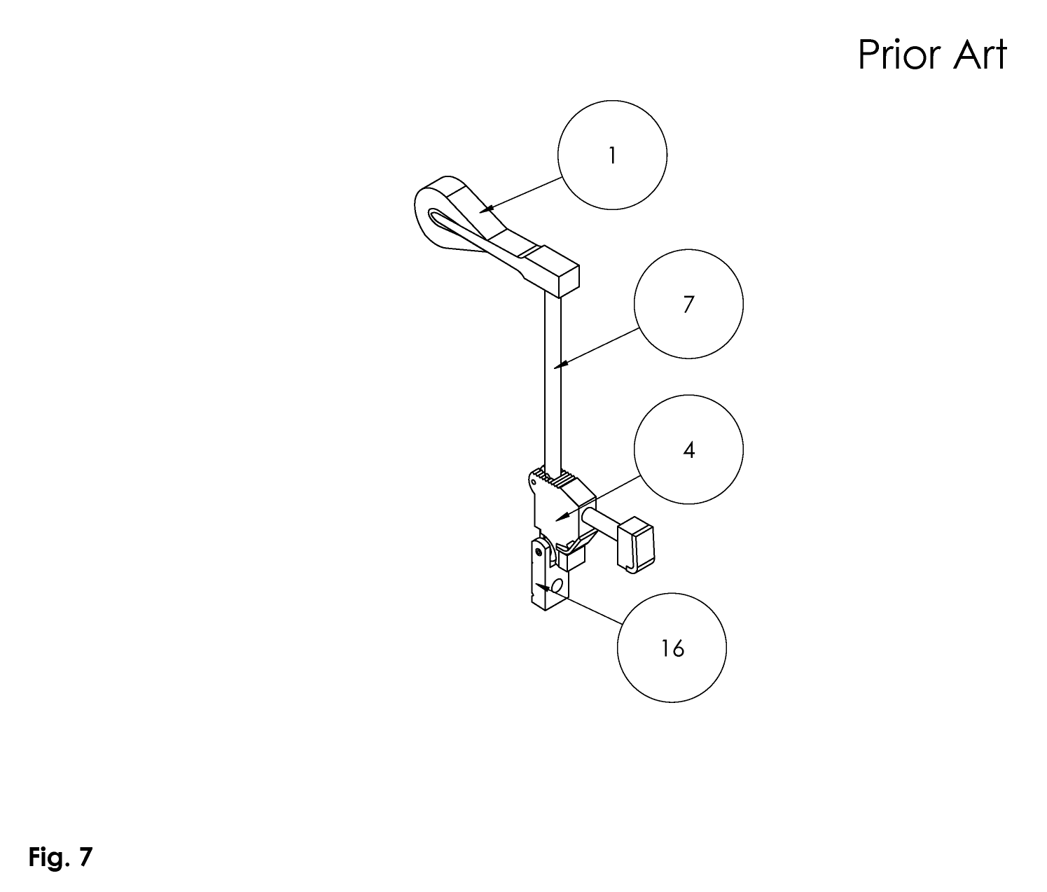

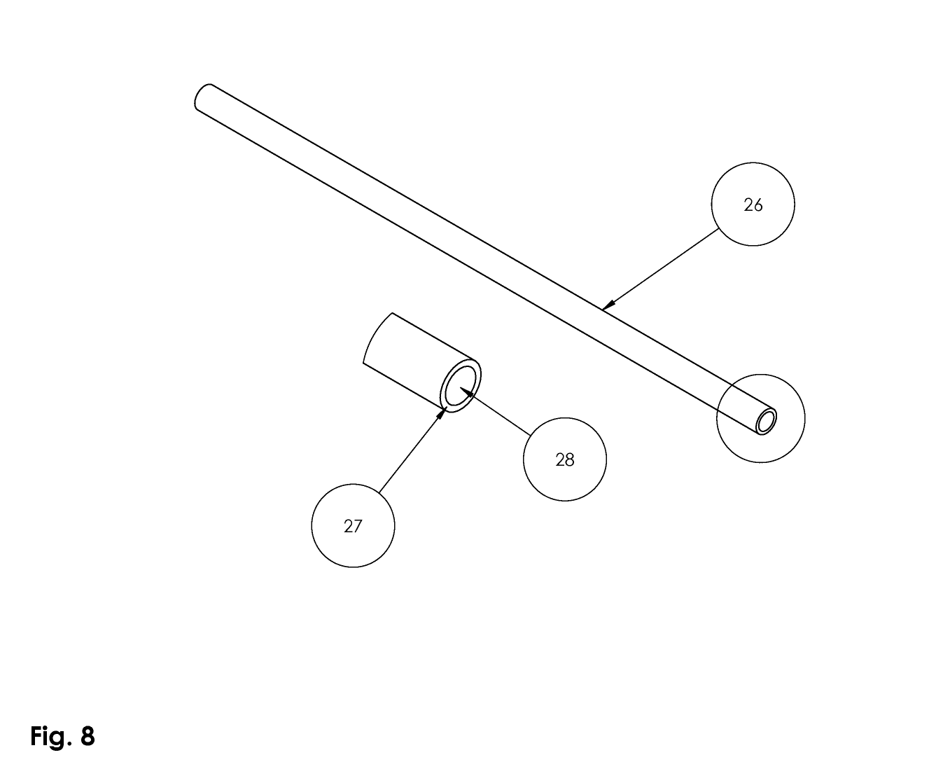

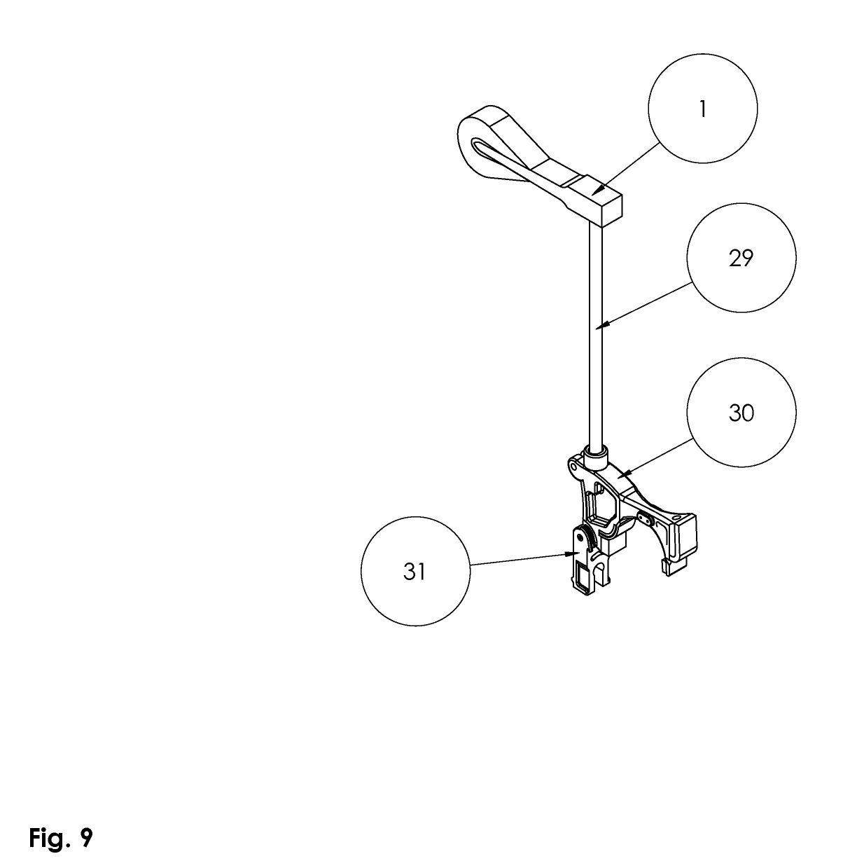

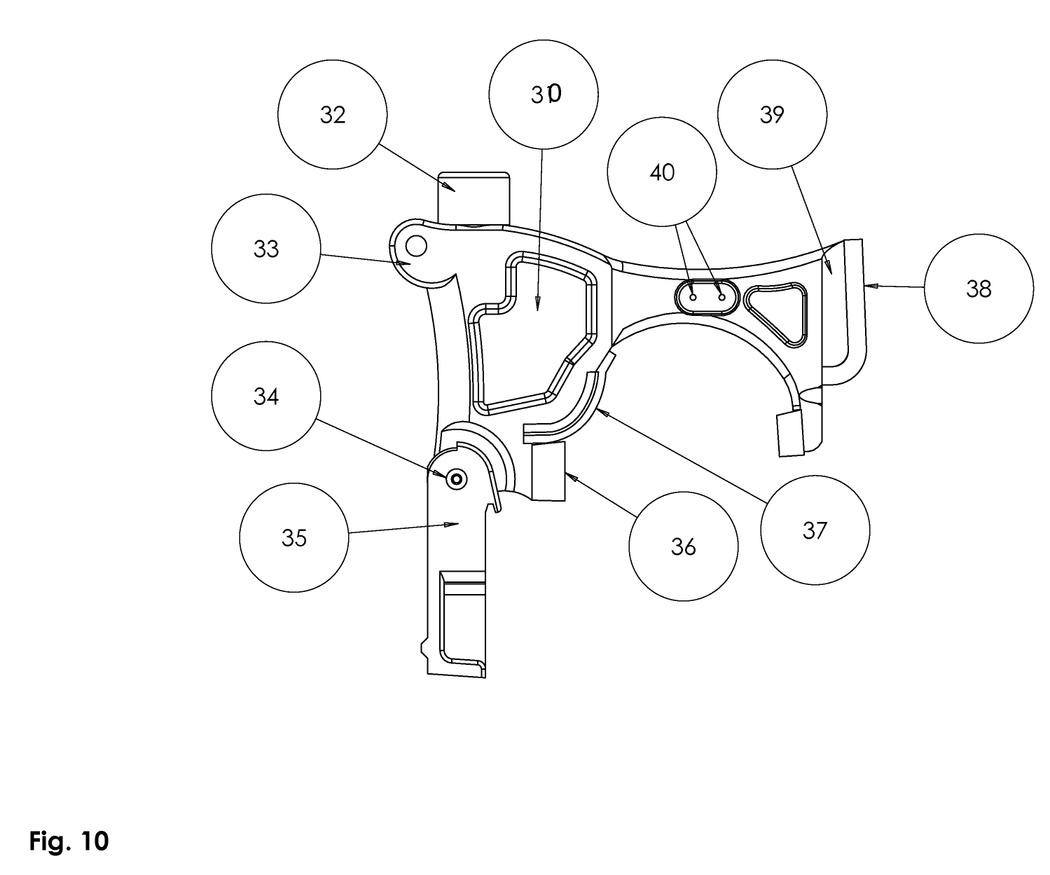

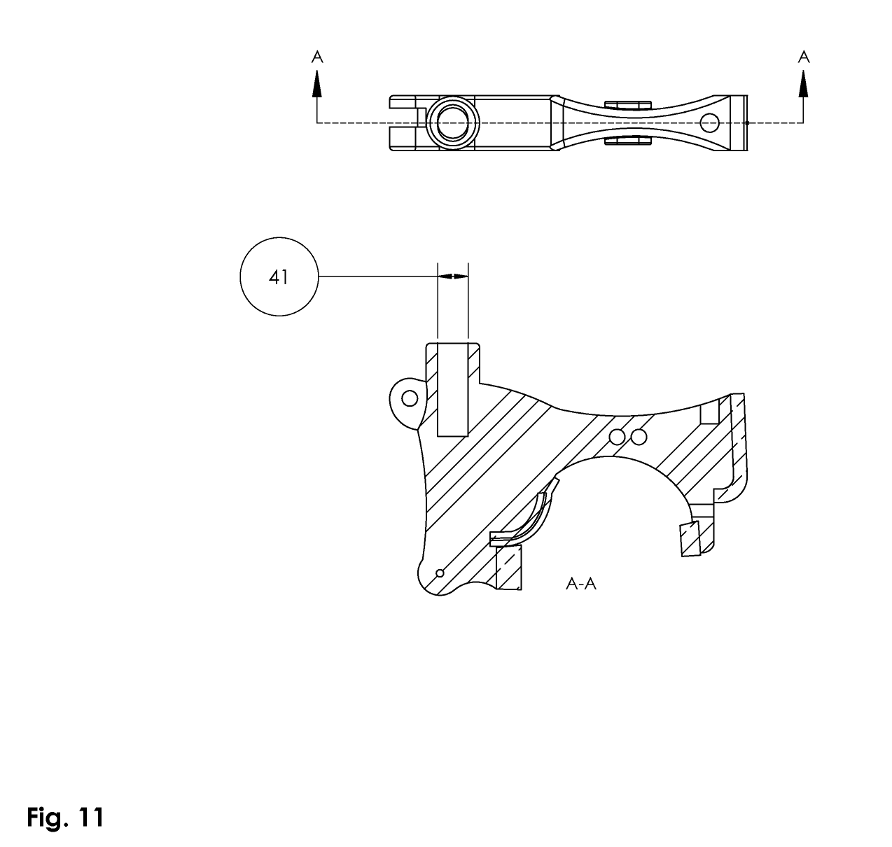

FIG. 5 depicts the prior art cylindrical hammer shank hole 22 for the hammer shank. FIG. 6 depicts the hammer shank after the shaving or tapering on the side of hammer shank at 23. As stated above, there is typically no shaving or tapering on the front or back of the hammer shank at 24. FIG. 6 depicts a point in assembly just prior to the final installation and adjustment of the hammer shank to the hammer butt. FIG. 7 depicts the assemble after final installation and adjustment of the hammer shank to the hammer butt. Thus, in this way, the piano assembly technician is given the ability to adjust each hammer shank angle by about 0-10 degrees to the left or right.

This invention preserves ability for the piano assembly technician to make this adjustment without shaving or tapering the hammer shank 7, 26, 29. The shaving or tapering of a hammer shank 7, 26, 29 is to be avoided when using a thin-walled hollow hammer shank 7, 26, 29. See FIG. 8 for a depiction of a thin-walled hollow hammer shank 26 with thin wall 27 and hollow area 28. The applicants teach the use of a thin-walled hollow hammer shank 26 because this design yields a lighter hammer shank, which, in turn, significantly reduces the inertia requirement to cycle the piano action. A lower inertia action is more pleasurable for the pianist to play.

The invention achieves this with a specially designed hammer butt 30 with a half-conical shaped hammer shank hole 41, 42, 43, 44, 45, 46, 47. FIG. 11 depicts a lateral or side cross section of hammer butt 30. It can be seen from this cross section that the hammer shank hole appears cylindrical in this dimension in that there are no tapered sides along this axis, which is the front-to-back axis. Thus, there is no taper or conical shape front-to-back.

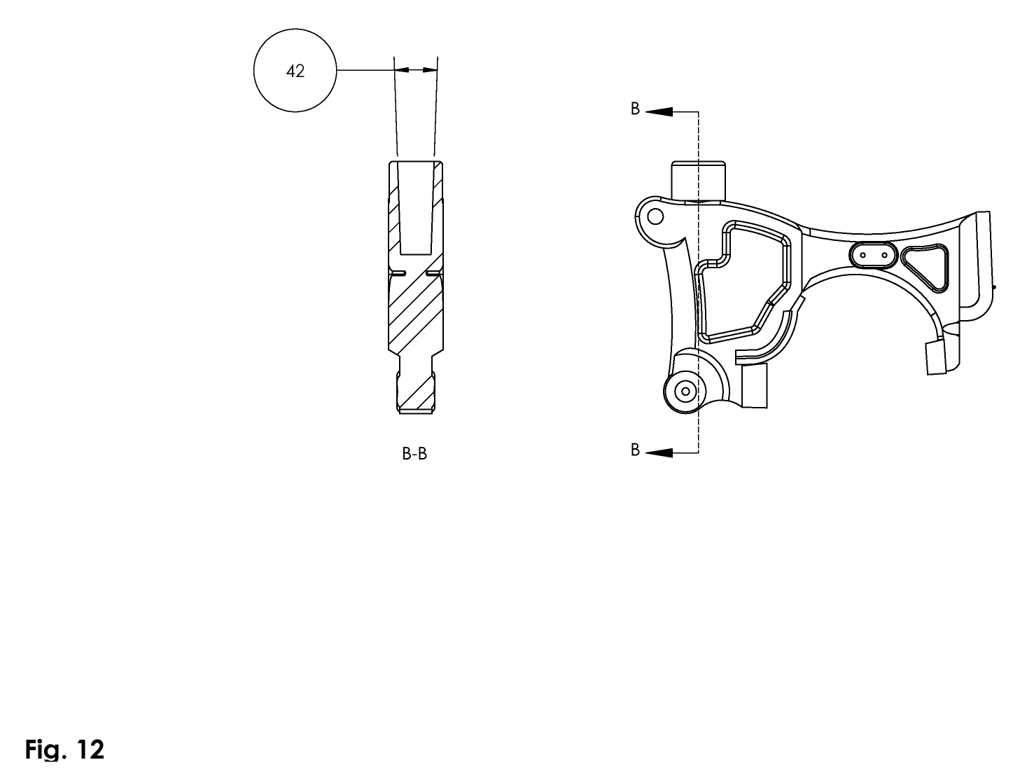

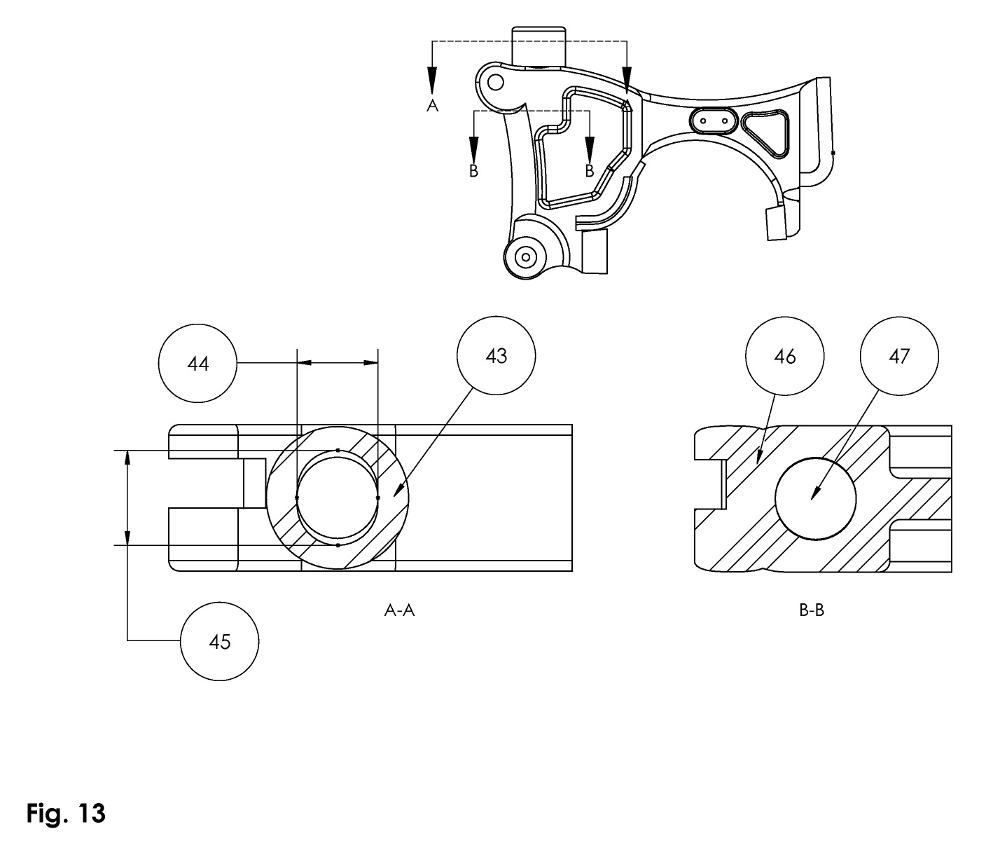

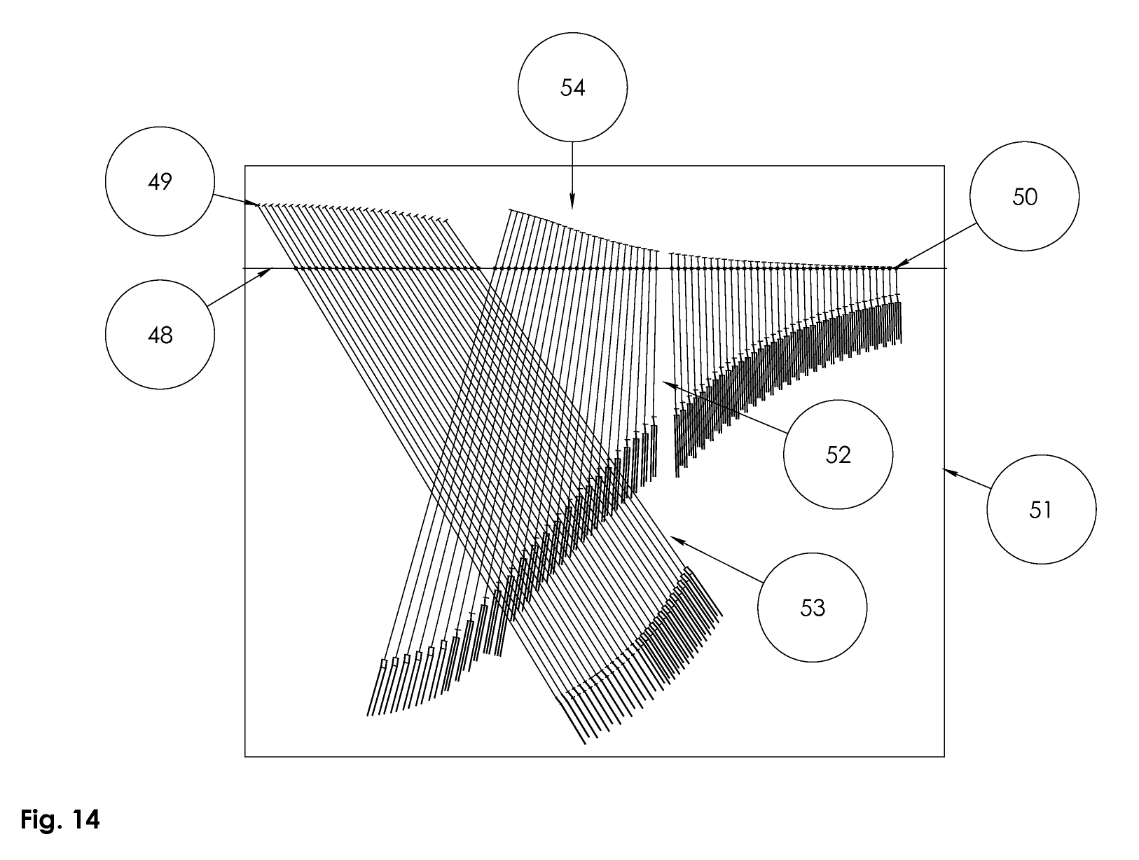

FIG. 12 depicts a longitudinal or front cross-section of hammer butt 30. Conversely, it can be seen from this cross section that the hammer shank hole appears trapezoidal with conical sides in this dimension in that there are tapered sides along this axis in concave upward orientation. This is the side-to-side axis. The angle of this taper as measured from the vertical plumb line can range from about 0.1-10 degrees. Thus, there is conical shape side-to-side. Hence, the description as a hammer butt with half-conical hammer shank hole.

What is claimed:

1. A hammer butt for an upright piano comprising: a hinge pin hole; a jack contact area; and a half-conical hammer shank hole; wherein,
said hinge pin hole is located on the bottom of said hammer butt and is capable of accepting and mating with the hinge pin from a hammer butt flange to form a hinge member with the hammer butt flange,
said jack contact area is a protuberance on the bottom of said hammer butt, in front of said hinge pin hole, where the jack contacts said hammer butt and pushes upwards upon said hammer butt, as the corresponding piano key is depressed, in order to rotate said hammer butt around the hinge pin, and
said half-conical hammer shank hole is located on the top of said hammer butt and has a cylindrical-shaped cross section [41] as viewed from the side of said hammer butt flange and a trapezoidal-shaped cross section [42] as viewed from the front of said hammer butt, with the bottom of said half-conical hammer shank hole representing the short side of said trapezoidal-shaped front cross section.

2. A hammer butt for an upright piano as recited in claim 1, wherein said trapezoidal-shaped cross section [42] of said half-conical hammer shank hole has sides set at and angle from vertical plumb ranging from plus or minus 0.1-10 degrees.
